(19) United States
(12) Patent Application Publication
(10) Pub. No.: US 2014/0367941 A1
(43) Pub. Date: Dec. 18, 2014

(54) Cycling Vehicles such as Bicycles

(71) Applicant: Aston Martin Lagonda Limited, Warwickshire (GB)

(72) Inventor: Ulrich Bez, Warwickshire (GB)

(21) Appl. No.: 14/367,019

(22) PCT Filed: Dec. 20, 2012
(86) PCT No.: PCT/GB2012/053209

§ 371 Date: Jun. 19, 2014

(30) Foreign Application Priority Data
Dec. 20, 2011 (GB) 1122023.3

(51) Int. Cl. B62K 25/04

(52) U.S. Cl. CPC B62K 25/04
USPC 280/259; 280/288.4

(57) ABSTRACT

A cycling vehicle (10) comprising a frame (12) and a drive wheel (14) connected to the frame (12) by a suspension (18). The suspension (18) comprises a strut (18) extending from the frame (12) to a central axis of the drive wheel (14). The strut (18) is a counterlevered from the frame (12) and is arranged set so as to be dynamically variable in length in order to provide suspension travel.

The present invention relates to cycling vehicles, such as bicycles, for example, bicycles, including those typically pedalled substantially by human power.

It is known to provide a bicycle with a rear suspension travel system, but such systems are often complicated. Some rear suspension systems for bicycles can have the rear wheel axle pivotable about a point near to a main front pedalling sprocket. Under high pedalling load, the power being supplied by the rider can therefore be undesirably transferred into a “winding-up” of the rear suspension instead of into rotational drive from the rear wheel onto the ground surface at least to a certain extent, and this is wasteful of the rider's power. Suspension travel can also cause a significant slackening or tightening action on a drive chain arranged between a drive sprocket on a drive wheel and the main front pedalling sprocket. Furthermore, some bicycle frames use a significant amount of material for holding the wheels of the bicycle and manufacture requires a fairly large number of parts.

EP0621171A discloses a two-wheeled motor vehicle with a rear wheel connected to the frame by both a generally horizontally extending member and a generally upwardly extending member including a spring. DE29721238U discloses a two-wheeled vehicle having a rear wheel attached to a main frame of the vehicle through an upwardly extending leg.

The present invention aims to alleviate at least to a certain extent at least one of the problems of the prior art. Another aim of the invention is to provide a useful cycling vehicle.

According to a first aspect of the present invention there is provided a cycling vehicle comprising a frame and a drive wheel connected to the frame by a suspension, the suspension comprising a strut extending from the frame to a central axle of the drive wheel, wherein the strut is cantilevered from the frame and is arranged to be set so as to be dynamically variable or adjustable in length, such as by being telescopic, so as to provide suspension travel. This arrangement is simple since a single strut may be provided for holding the drive wheel. The frame is preferably a main frame of the cycling vehicle, such as one to which other main components of the vehicle such as a saddle, handlebars, steering wheel assembly and main sprocket/pedals may be mounted.

The strut may be arranged to extend in a generally vertical direction down from the frame to the central axle of the drive wheel. In a convenient way therefore, vertical suspension loads on the strut may result in the strut adjusting in length. The strut may include two components which are telescopically slidable relative to one another. The strut may include within it or as part of it spring and/or damper components. The spring and/or damper components may be adjustable in spring constant and/or or damping strength. The damper may incorporate a minimum load threshold device, such that below certain loads on the strut the strut does not adjust in length, thereby avoiding unnecessary consumption of energy as the cycling vehicle encounters minor bumps and/or changes in load.

The strut may extend in a generally straight line at up to about 5 to 10 degrees (or up to about 20 degrees) forwardly from vertical as it extends downwardly to the central axle from the frame, approximately 2 to 5 degrees of forward lean being the case in some examples. The lean angle may be higher in some other embodiments such as up to about 30 or up to about 45 degrees.

According to a further aspect of the present invention there is provided a cycling vehicle having a frame, at least one drive wheel, and a strut connecting the frame to a central axle of the drive wheel, the strut having two ends, a generally straight line between the two ends being oriented at up to about 20 degrees forwardly from vertical as it extends downwardly from the frame to the central axle, the strut being cantilevered from the frame. This is an advantageous format for the vehicle which enables a system with good positioning and control of the drive wheel relative to the frame.

The strut may be adjustable in length, such as by being telescopic, so as to provide suspension travel. In this case, due to the forward lean of the strut and the way in which a drive element, such as a chain, of a cycling vehicle normally leans slightly upwards from a rear sprocket on the drive wheel to a larger sprocket mounted on the frame at a pedalling axis, suspension travel at the strut of minor amounts does not significantly vary the chain length. Also, pedalling or other drive forces do not tend to try to wind-up the suspension as may otherwise be the case.

In either of the above aspects of the invention, the cycling vehicle may include a main sprocket which is connected by a drive member, such as a chain, to a drive sprocket concentric with the central axle of the drive wheel, the drive member having, at a time when it is supplying drive to the drive member, a generally straight drive section, the generally straight drive section in at least one configuration thereof being substantially perpendicular to an imaginary line between the central axle and a point of attachment of the strut to the frame. When the strut is substantially straight or straight, the imaginary line may be coincident with a longitudinal axis of the strut. This substantial perpendicularity is advantageous since small variations in suspension travel do not significantly alter a drive length of the drive member between the main sprocket and the drive sprocket, since a graph of chain length against suspension travel has zero gradient. Preferably, the strut is tuneable and tuned (e.g. spring constant or other spring adjustment) to achieve this perpendicularity with a rider's weight applied to the cycling vehicle in a normal riding position, e.g. with the rider sitting on a seat member of the cycling vehicle.

The strut may be cantilevered from the frame in that it has one end thereof fixed to and immobile relative to the frame. The strut may be cantilevered from the frame without bracing and/or without structural connections from the frame between a point of attachment of the strut at one end thereof to the frame and another end thereof at the drive wheel axle. Thus, a simple structure without a significant number of parts may be achieved.

The strut may extend on one side only of the drive wheel, the drive wheel having no support applied from the other side thereof. The drive axle may therefore be mounted cantilevered from and substantially perpendicular to a longitudinal extension direction of the strut. This provides a very simply structure without using a significant amount of material for the components supporting the drive wheel relative to the frame.

The strut may normally be straight, although in other embodiments a curved or other shape may be used.

The drive wheel may be rotatable relative to the frame only about the drive axle. Therefore, the strut and drive axle themselves may be unable to rotate their positions relative to the frame, although the strut, when adjustable in length, may allow the axle to translate relative to the frame.

The drive wheel may be a rear wheel.

The cycling vehicle may be of a type which is intended to be leaned to one side when turning a corner. The cycling vehicle may be a bicycle, such as a pedal cycle. Thus, the drive wheel may be a rear wheel of a bicycle.

A second wheel may be provided for the cycling vehicle, such as a front wheel, and may be supported, on a single side thereof only, by a strut extending from the frame to a central axle of the second wheel. In this case, the struts of the drive wheel and the second wheel may be formed of components substantially identical to one another, although the second wheel may be provided with a hinging joint to the frame in order to provide steering rotation of the second wheel and its strut relative to the frame. The strut of the second wheel may be fixed to steering apparatus, such as handlebars of the cycling vehicle. The use of substantially identical struts for the drive wheel and second wheel significantly lowers the cost of production and the supply chain for both original production and spare parts.

The cycling vehicle may have a gear control located passing through inside the axle of the drive wheel from one side to another side of the drive wheel. Therefore, gear control commands and, in some embodiments, power for gear changes may be passed from the frame, along the strut and then through the axle or along inside the axle to a side of the drive wheel opposite the strut. This may enable either mechanical or hydraulic or electric control of the gear change of a multiple-gear sprocket such as a 5 or 7 gear sprocket arrangement concentric with an arranged to drive the drive wheel, for example by a unidirectional clutch or ratchet, to be passed along or inside the strut and axle internally. Therefore, mechanical, hydraulic or electric cables passing directly between the frame and gear change mechanism for the multi-gear sprocket, which could become tangled when cycling in difficult environments, is not necessary.

A further aspect of the invention provides a cycling vehicle having a frame and a seat member on which a rider may rest the rider's body during cycling, the frame having an extension portion thereof which is substantially a rearward extension of the seat member in at least one position of the seat member, thereby enabling sliding movement of the rider's body between the seat member and the extension portion. This configuration is highly advantageous since it enables the rider, for example, when cycling uphill or on a level surface to sit on the seat, but when cycling down a steep surface, such as on a mountain, the rider may slide backwards and place their body' weight on the frame. The seat member and/or rearward extension may comprise a solid or unbroken support surface extending substantially fully thereacross and/or therealong, thereby providing good comfortable support.

The seat member may be adjustable by an adjustment assembly thereof so as to be locatable in more than one position relative to the frame. The seat member may be slidable backwards and forwards and/or up and down. The seat member may also be capable of adjustment in rotation, such as by being capable of rotating about a generally horizontal axis transverse to a longitudinal direction of the cycling vehicle.

In any of the above-mentioned aspect of the invention, the frame may be a unitary composite structure, such as a carbon fibre composite structure. The frame may have hollow portions therein, such as for containing hydraulic components, such as for controlling braking or gear changes and/or for containing electrical and/or electronic components, such as for powering lights or electronic navigation apparatus or gear change apparatus of the cycling vehicle, and or for accommodating auxiliary motor and/or regenerative braking components of the cycling vehicle.

In any of the above aspects, the cycling vehicle preferably includes foot pedals mounted on crank arms to enable a rider to power the vehicle along. The cycling vehicle may include an auxiliary motor which may be arranged for manual operation by a rider of the vehicle and/or for automatic operation in response to prevailing conditions, such as switching on the auxiliary motor when a strain gauge measurement in a pedal crank handle (or another value measured by a device and indicative of effort above a threshold) exceeds a certain value and switching off operation of the auxiliary motor when a brake of the cycling vehicle is applied.

The cycling vehicle may be provided with a regenerative braking generator which may apply braking force to the cycling vehicle when a brake of the vehicle is activated. The regenerative braking generator may be arranged to charge-up a power source of the vehicle, such as a battery for powering the auxiliary motor when the auxiliary motor is an electric motor. Other power arrangements are envisaged other than electric, such as compressed air motor and regenerative power storage.

A further aspect of the invention provides a handle and braking assembly for a cycling vehicle, the handle being a generally cylindrical member which is grippable and arranged to be mounted on a steering handlebar arrangement, the handle being rotatable about a longitudinal axis thereof for operating a braking assembly portion of the vehicle. Accordingly, when the handle and braking assembly is mounted on a cycling vehicle such as a bicycle, the brakes may be applied by rotating the handle. This arrangement avoids the incorporation of an arm-like braking handle and may be advantageous, for example when cycling through difficult terrain such as woodland since it avoids catching and operation of the brakes by items such as branches of trees which the cycling vehicle is passing as it is ridden.

The braking assembly portion may include a hydraulic operation device. Hydraulics may therefore be used for operating brakes on the cycle instead of mechanical Bowden cables which are subject to stretching and undesirable variation in the brake characteristics whereas, with disc brakes and callipers fed by a hydraulic master cylinder and operated by the braking assembly portion, similar problems do not arise.

The present invention may be carried out in various ways and a specific embodiment of a cycling vehicle in the form of a bicycle in accordance with the invention will now be described by way of example with reference to the accompanying drawings, in which:

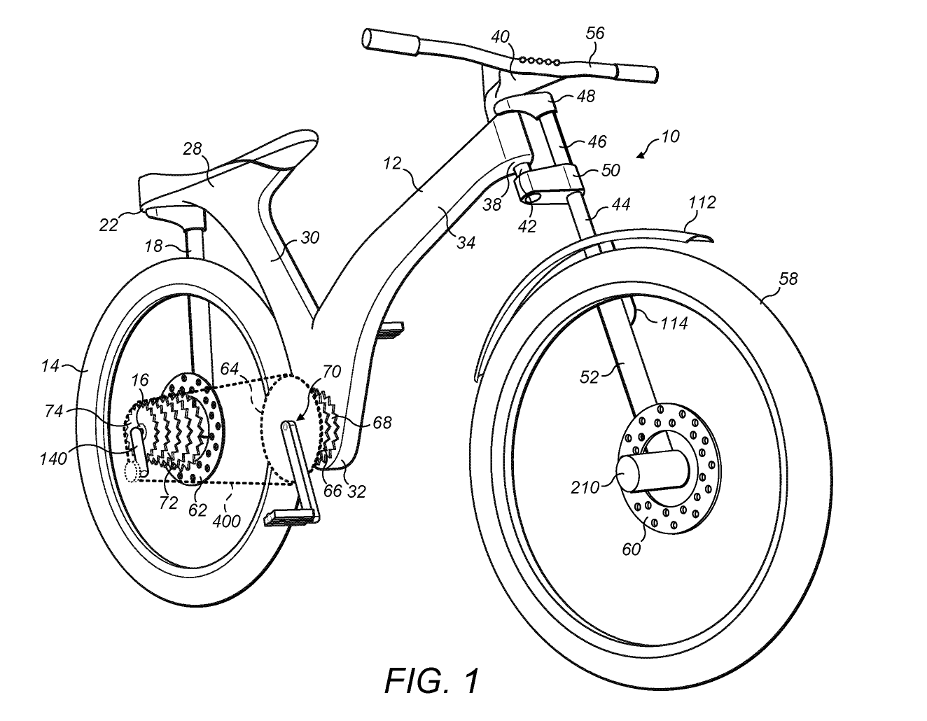

FIG. 1 is a schematic, perspective part-view from a front quarter of a bicycle in accordance with a preferred embodiment of the present invention;

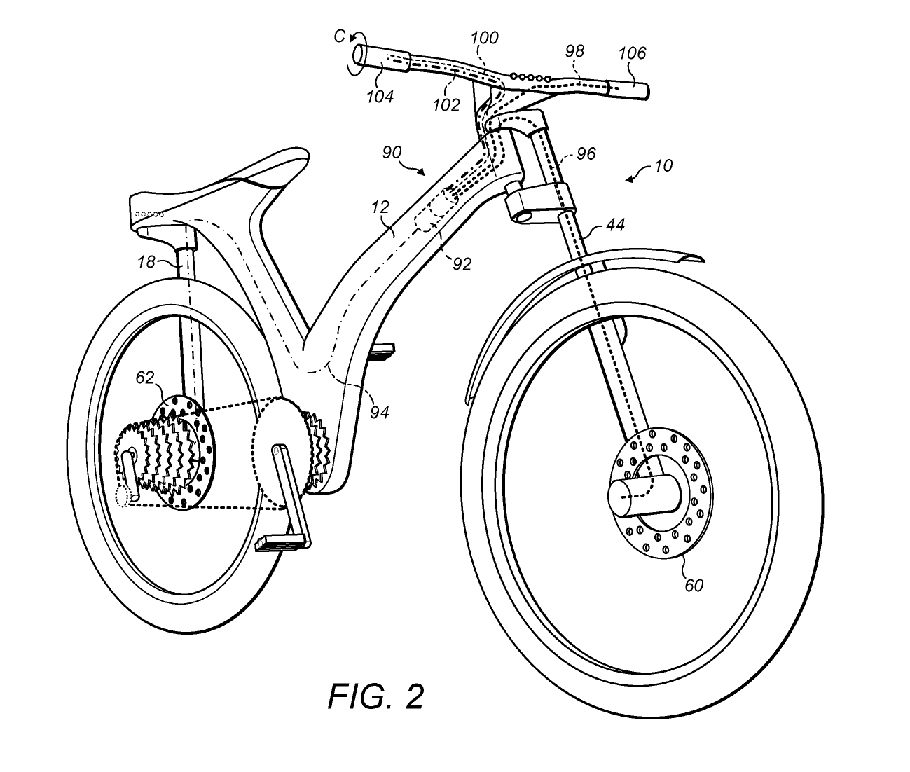

FIG. 2 is a view similar to FIG. 1 but showing certain hydraulic pathways;

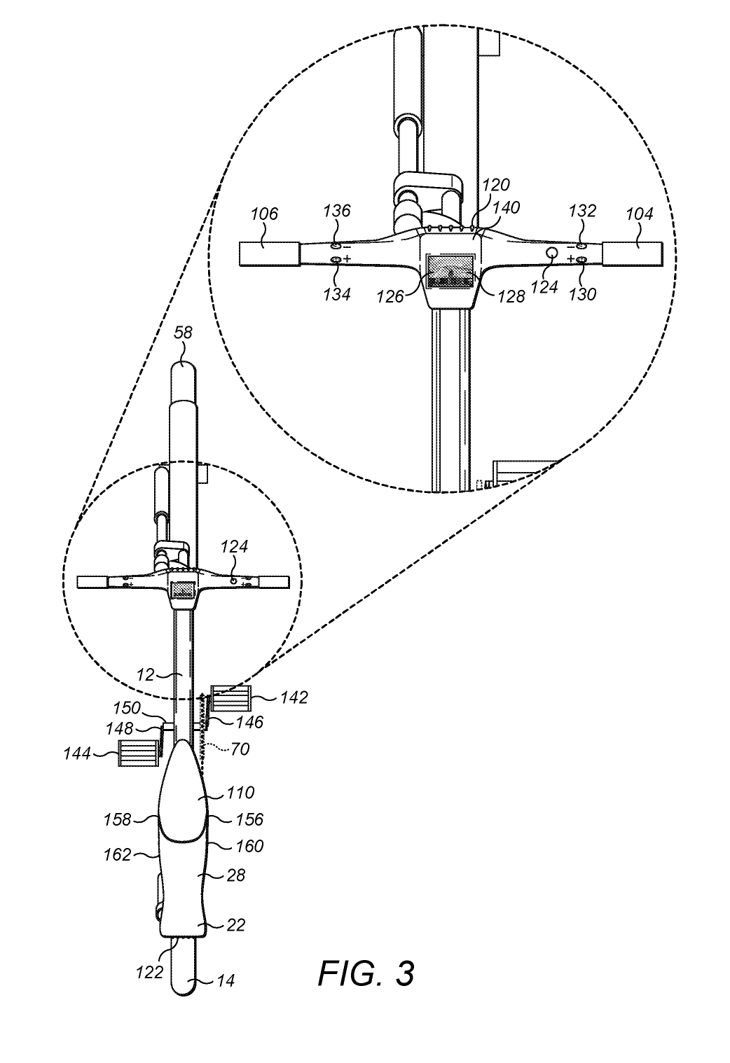

FIG. 3 is a view from above of the bicycle of FIGS. 1 and 2;

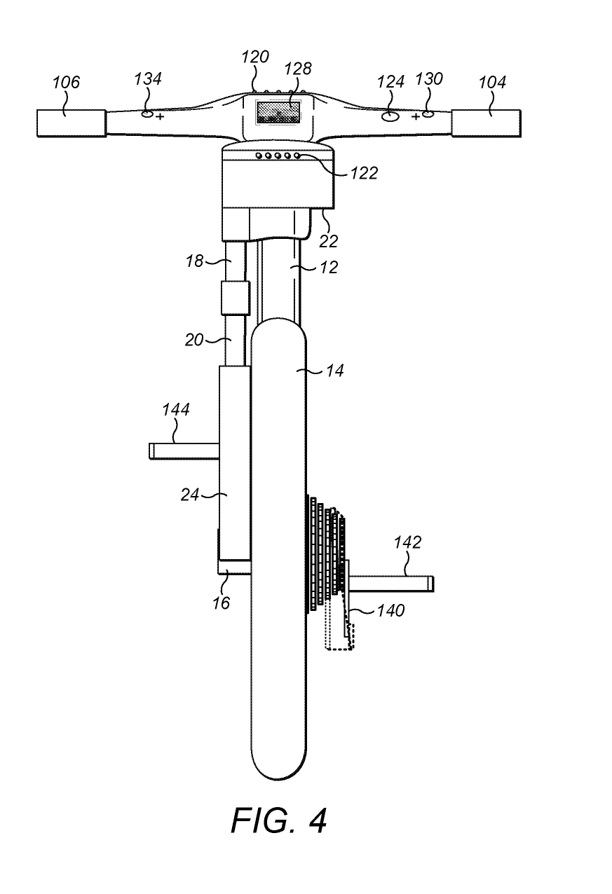

FIG. 4 is a view from behind of the bicycle of FIGS. 1 to 3;

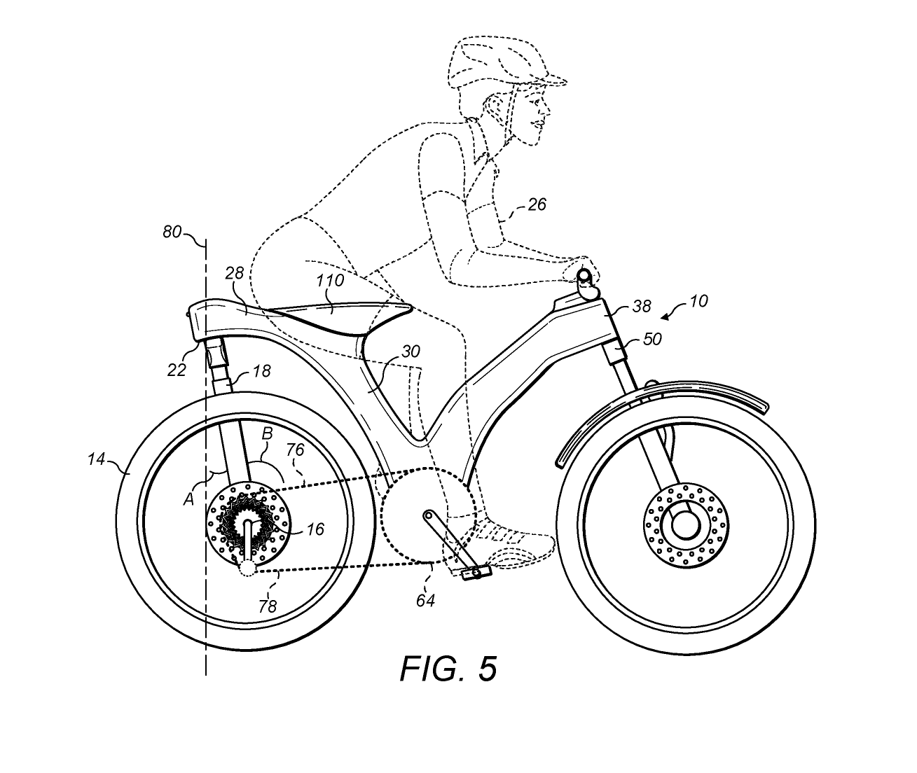

FIG. 5 is a schematic view from one side showing the bicycle of FIGS. 1 to 4 being ridden along a generally level surface, the bicycle having a slightly different steering connection between a front fork and frame thereof;

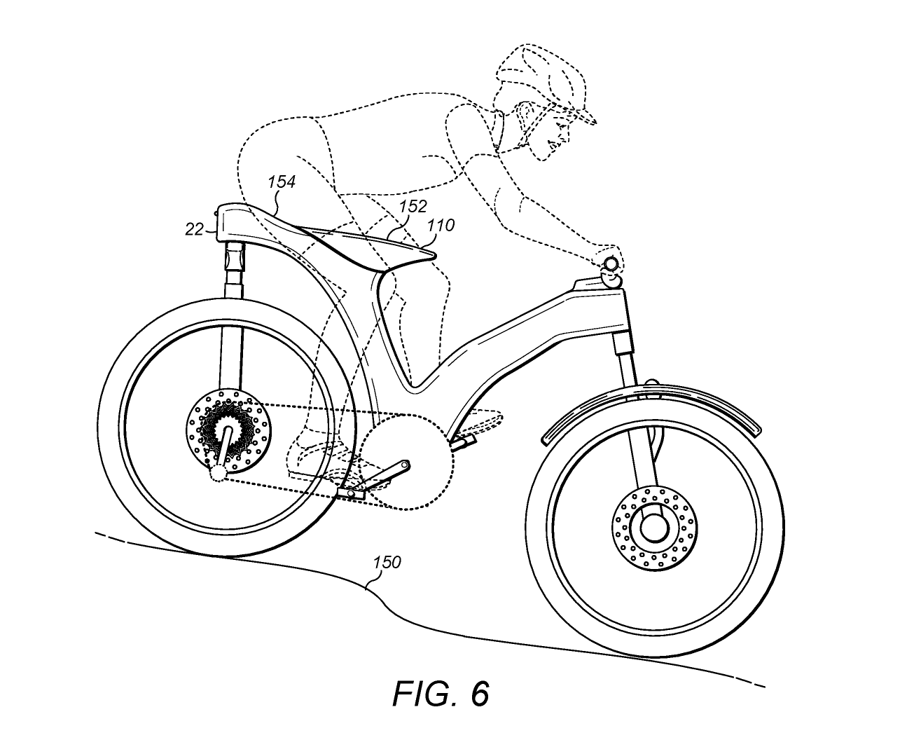

FIG. 6 is a view equivalent to FIG. 5 but showing the bicycle being driven down a steep surface;

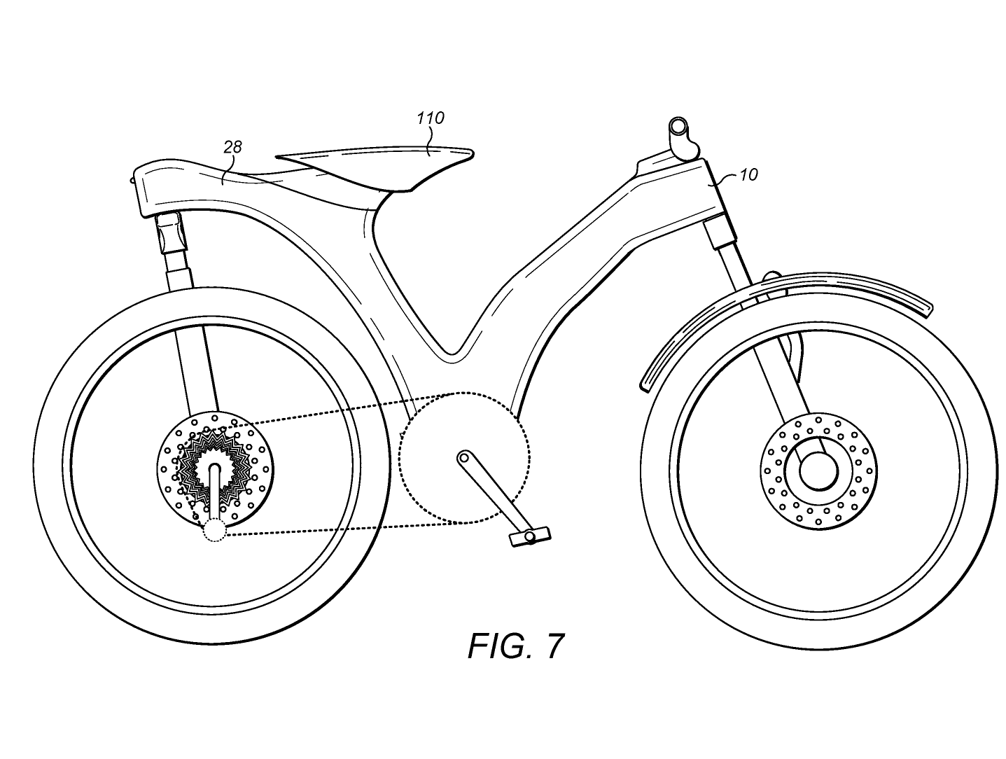

FIG. 7 is a schematic side view of the bicycle of FIGS. 5 and 6 with a seat member thereof moved to a different position to that shown in the earlier figures; and

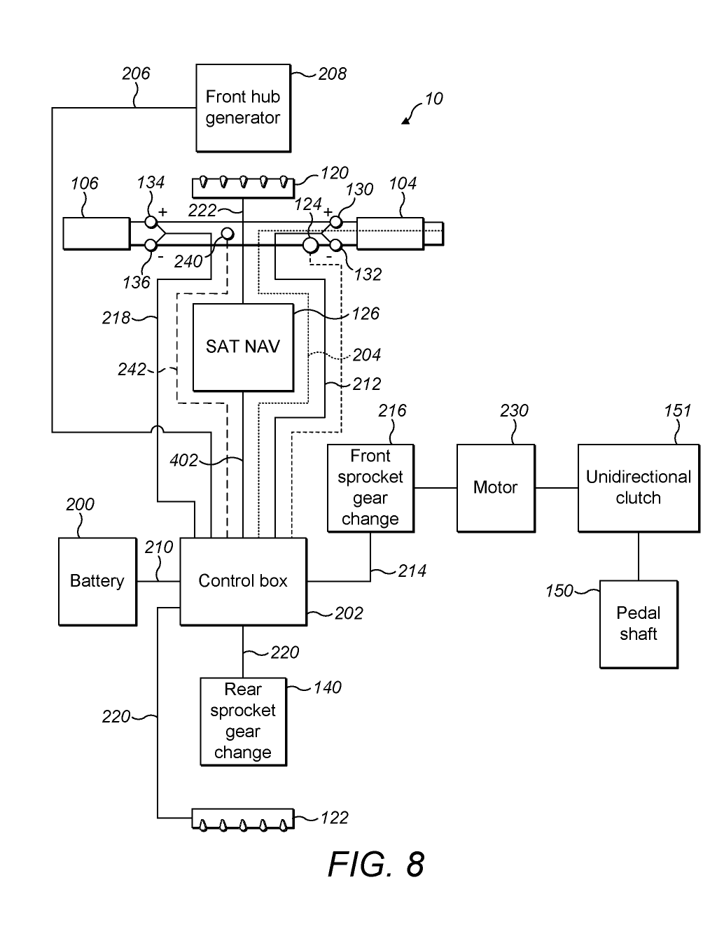

FIG. 8 shows an electrical/electronic layout for the bicycles shown in FIGS. 1 to 7.

As shown in FIG. 1, a bicycle 10 in accordance with a preferred embodiment of the present invention includes a main frame 12 made of carbon fibre composite material in a unitary structure. A rear wheel 14 is connected to the frame 12 via spokes (not shown), an axle 16 and a telescopic generally vertically oriented strut 18 having a top portion 20 fixedly mounted to a rearmost portion 22 of the frame and a bottom portion 24 which is fixed to the axle 16. The top portion 20 and bottom portion 24 are telescopically slidable relative to one another along the length of the strut 18 and the strut includes spring and damper components (not shown) for providing a rear suspension travel of approximately 80 to 100 millimetres. The spring constant and damper strength may be adjusted by adjustment means (not shown) operated by the rider 26 in order to vary ride height and suspension characteristics accordingly. A lock (not shown) may also be provided for selectively locking the top portion 20 and bottom portion relative to one another in length. The bottom portion 24 can slide relative to the top portion 20 but cannot rotate relative to it.

The frame 12 is generally a V-shaped form 12 when viewed from the side and includes an upper rear portion 28 joined by a generally straight portion 30 to a lower middle portion 32, the lower middle portion 32 being joined by a generally straight portion 34 to an upper front portion 36 which carries a headset bearing 38. A handlebar assembly 40 is rotationally mounted to the headset bearing 38 by a bearing shaft 42. A front strut 44 with the same suspension functionality as the rear telescopic strut 18 has its top portion 46 fixedly mounted to the bearing shaft 42 by upper 48 and lower 50 brackets. Like the rear strut 18, the front strut 44 has a lower portion 52 which is telescopically slidable relative to the top portion 46, but rotationally fixed relative to it. The front strut 44, like the rear strut, also includes springs and dampers (not shown) whose spring constant and damper strength can be adjusted by the rider 26. Also in a similar way to the rear strut, the front strut may be selectively locked in length by a lock (not shown) if desired. A front hub 54 is fixed to the lower portion 52 of the front strut 44. Since the front strut 44 is rotationally fixed relative to both of the bearing shaft 44 and handlebar assembly 40, as the handlebars 56 of the handlebar assembly 40 are rotated about the axis of the bearing shaft 42, the front strut 44 also rotates by the same amount, as do the front hub 54 and front wheel 58 which is attached to the front hub 54 by spokes (not shown).

The front wheel 58 and rear wheel 14 also have brake discs 60, 62 which rotate with the wheels 58, 14 and are braked by brake callipers (not shown) which are attached in a conventional way to the lower portions of the struts 52, 24.

As shown in FIG. 5, when viewed from one side, the rear strut 18 extends downwardly and forwardly from the rearmost portion 22 of the frame to the axle 16 at an angle A, which in this embodiment is about 10 degrees. In other embodiments, this lean angle may be larger or smaller, such as within the range of about 2 to 10 degrees, about 2 to 5 degrees being selected in some embodiments. The angle A is chosen such that a selected gearing or an average gearing between the three selectable front cogs 64, 66, 68 (of the main sprocket 70 attached to the lower middle portion 32 of the frame 22) and cogs 72 of a rear sprocket 74 will allow to generally straight and tensioned upper part 76 of a bicycle chain 78 will be at an angle B to the length of the rear strut 18. Therefore, as the upper part 76 of the chain 78 is tensioned by the action of the main sprocket 70 in response to peddling, the chain forces do not easily wind up the suspension thereby conserving energy. The rear strut 18 may include a minimum load threshold device (not shown) in a damper (not shown) thereof, such that below a threshold of variation in load on the strut, the strut does not adjust in length. This may advantageously avoid unnecessary consumption of energy as the bicycle encounters minor bumps and/or changes in load, and minor variations in torque applied by the rider (and/or a power source) below the threshold do not result in power lost in the suspension damper or in the strut more generally. Also, as the bicycle 10 travels over small bumps, minor changes in length of the rear telescopic strut 18 do not substantially affect the length of the upper part 76 of the chain 78 between the front 70 and rear 74 sprockets such that a smooth riding action is achieved. Means may be provided for varying the threshold.

It will be appreciated that the angle A is the angle between the direction of extension of the rear strut 18 and a vertical plane 80. In other embodiments, the rear strut 18 may be leant forwards more or less than the approximately 10 degree angle shown in FIG. 5. This variation may take into account anticipated ground reaction forces and/or braking forces produced on the strut by the 18 by the wheel 14 as well as the forces from the chain 78.

FIG. 2 shows a hydraulics arrangement 90 for the bicycle 10. The hydraulics arrangement 90 includes a master cylinder 92 connected by a hydraulic tube 94 running inside or alongside the frame 12 and rear strut 18 to a rear brake calliper (not shown). The master cylinder 92 is also connected by a hydraulic line 96 running through or alongside the frame 12 and front strut 44 to the front brake calliper (not shown). The master cylinder is also attached by one or two hydraulic lines 98, 100, 102 to each of cylindrical right 104 and left 106 brake actuator handles. Rotation of each cylindrical handle 104, 106, in the direction C, which is anticlockwise when the bicycle 10 is viewed from its right hand side, causes hydraulic fluid to flow from the respective handle 104, 106 via the master cylinder 92 via a respective one 94, 96, of the hydraulic lines to either the front or rear brake calliper to apply the brakes. The right hand handle 104 operates the front brake calliper to act upon the front brake disc 60 and the left handle 106 acts upon the rear calliper to act upon the rear brake disc 62. Each handle 104, 106 is thus rotatable relative to the handlebar 56 and includes a hydraulic actuator (not shown) for applying pressure in the lines 98, 100, 102 as appropriate, as the handles 104, 106 are rotated. In addition to having a clean appearance, this braking system is also technically advantageous since if the bicycle 10 is ridden close to objects such as tree branches or alongside walls and should inadvertently hit or scrape them, the brakes are not necessarily applied, and they are not applied so easily as with a conventional bicycle having brakes operated by levers which extend from and are generally moveable back towards the handlebars for operation thereof. Such levers can catch upon objects close to the bicycle and apply the brakes undesirably.

FIG. 3 shows how the rearmost portion 22 of the frame 12 in the region of the upper rear portion behind a seat member 110 is significantly wider than the generally straight portion 30, lower middle portion 32, generally straight portion 34 and upper front portion 36 of the main frame 12. Thus, upper rear portion of the frame 12 acts very effectively as a rear mud guard. As shown in FIG. 1, a front mud guard 112 is attached by a connector 114 to the lower portion 52 of the front strut 44. The front mud guard 112 is made of carbon fibre composite material.

Also as shown in FIG. 3 an LED array 120 is formed in a central part of the front of the handlebar assembly 40 and rear LED array 122 is mounted in the rearmost portion 22 of the frame 12. These LED lights 120, 122 are operable by a light switch 124.

The handlebar assembly 40 also includes an information device 126 including a navigation (e.g. satnav) screen 128 as well as up-change 130 and down-change 132 buttons for electronic control of the selection (for chain mesh) of the front cogs 64, 66, 68 using a front derailleur (not shown), as well as up-change 134 and down-change 136 buttons for electronic control of the selection of cogs 72 on the rear sprocket 74 using rear derailleur 140.

As shown from above in FIG. 3, the main sprocket 70 can be driven using foot pedals 142, 144 operating via cranks 146, 148 attached to sprocket axle 150.

As shown in FIG. 5, when the rider 26 is riding the bicycle 10 along a generally horizontal surface, the rider may conveniently sit on the seat member 110 which is wider than the generally straight portion 30 of the frame 12 and a similar width to the upper rear portion 28 of the frame 12.

As shown in FIG. 6, when the rider 26 rides down a steep surface 150, since the seat member 110 smoothly merges into the rearmost portion 22 of the frame 12, and has a top surface 152 substantially aligned with and merging into a top surface 154 of the upper rear portion 28 and side surfaces 156, 158 substantially aligned with and merging into side surfaces 160, 162 of the upper rear portion 28, the rider can easily slide backwards onto and be supported on the upper rear portion 28 of the frame 12 instead of a seat member 110. Thus, despite having a relatively small seat member 110, the rider still has substantial flexibility for riding under different conditions. Rearmost portion 22 and seat member 110 preferably have non-perforate upper surfaces so as to provide good rider support and in order to provide mudguard functionality.

As shown in FIG. 7, however, if the rider 26 so desires, the seat member 110 may be moved relative to the upper rear portion 28 of the frame to be mounted in one of a number of selected positions either further forward or higher than the seat position shown in FIGS. 5 and 6. Seat member 110 may be selectively locked in such positions by a seat lock (not shown). Rotational adjustment (by an adjuster (not shown)) of the seat member 110 about a horizontal axis perpendicular to a longitudinal direction of the bicycle is also envisaged.

It will be appreciated from FIGS. 5 to 7 that the handlebar assembly 40 is slightly different in these views than in FIGS. 1 and 2, as is the headset bearing 38 and as are the brackets 48, 50 and this simply reflects a minor variation between the embodiments.

FIG. 8 shows in block form various electric/electronic components of the bicycle 10, some of which have already been mentioned above.

As seen in FIG. 8, the bicycle 10 includes a battery 200 which is located within the frame 12, which is hollow. The battery is connected to a control box 202. When the right hand handlebar handle 104 is rotated to cause braking, a signal may be sent along a pathway 204 to the control box 202 which may draw a load along path 206 from a front hub generator 208 located inside front hub 210 of the front wheel 58, and the control box may charge battery 200 along path 210.

When either of the gear change buttons 130, 132 is pressed, a respective signal may be sent along signal path 212 to the control box 202 which may send a signal and power along path 214 to a front sprocket gear change module 216 which may electro-mechanically switch the chain 78 onto a different one of the front cogs 64, 66, 68.

Likewise, when one of the gear change control buttons 134, 136 is pressed, a respective signal may be sent along path 218 to the control box 202 which may send a signal and power along path 220 to the rear sprocket gear change derailleur 140. The axle 16 may be hollow and the path 220 may pass through or along the rear strut 18 to the axle 16 and may then pass through hollow axle 16 to the rear sprocket gear change module 140 (or derailleur) which may electro-mechanically switch the chain 78 on to another one of the cogs 72 of the rear sprocket 74.

The control box 202 may be arranged to supply power via paths 220 and 222 to the rear LED lamp assembly 122 and front LED lamp assembly 120, either directly or via another component, such as the information module (e.g. satnav) 126, which may, as indicated in FIG. 8, may comprise a satellite navigation module.

Additionally, the control box may be connected via the front sprocket gear change module 216 to an auxiliary motor 230 which may be arranged to provide driving force to the front sprocket shaft 150 either automatically based upon predetermined conditions (e.g. a strain gauge (not shown) on a pedal crank arm 146, 148 indicating rider effort over a threshold, or a heart monitor (not shown) on the rider indicating heart pulse rate over a set threshold value) or upon manual pressing of a drive button 240 on the handlebar assembly 40 which is arranged to send a signal to the control box 202 via a signal path 242. The motor 230 may act upon a motor shaft (not shown) which acts either indirectly or directly upon the front main sprocket 70, and the pedal shaft 150 may be coaxial with that shaft and attach thereto by a unidirectional clutch 151 such that when the auxiliary motor 230 is providing power the rider 26 does not necessarily need to turn the pedals 142, 144 and crank arms 146, 148.

The battery 200, control box 202, motor 230 may be located inside the frame 12 as may all of the various pathways shown in FIG. 8, such that the bicycle 10 has a very clean look.

The front strut 44 and rear strut 18 are substantially identical to one another apart from in that the rear strut 18 is set up during assembly so as to be slightly shorter and the front strut is hingedly coupled to the frame 12. This use of common parts substantially improves production costs and supply chain costs both for production and spare parts.

The suspension travel for each strut 18, 44 may be set as desired and may, for example, be somewhere between 80 and 100 millimetres.

In some cases, a second derailleur near the front sprocket may be provided to act on a lower side 400 of the chain 78 together with the derailleur 140 so as to allow for greater changes in length of the chain than with only the single derailleur 140.

The information device/system/module 126 may be removable and may have its own internal battery, but the connection 402 to it from the control box 202 may allow the information/navigation system 126, 128 to be charged from the battery 200 via the control box 202 while the bicycle 10 is in use. Removal of the system/module 126 may enable loading of data and charging as well as programming at a location remote from the bicycle 10.

Instead of providing a generator 208 in the front hub 210, one of the motor 230 or generator 208 could be removed and the other replaced with a motor generator.

Various changes may be made to the embodiments described without departing from the scope of the invention as defined by the accompanying claims.

1. A cycling vehicle comprising a frame and a drive wheel connected to the frame by a suspension, the suspension comprising a strut extending from the frame to a central axle of the drive wheel, wherein the strut cantilevered from the frame and is arranged to be set so as to be dynamically variable in length in order to provide suspension travel.

2. A cycling vehicle as claimed in claim 1 in which the strut is arranged to extend in a generally vertical direction down from the frame to the central axle of the drive wheel, the strut preferably being straight.

3. A cycling vehicle as claimed in claim 2 in which a line between two ends of the strut extends up to about 5 or 10 degrees forwardly from vertical as it extends downwardly to the central axle from the frame, the strut preferably being straight.

4. A cycling vehicle having a frame, at least one drive wheel, and a strut connecting the frame to a central axle of the drive wheel, a line between two ends of the strut extending up about 5 or 10 degrees forwardly from vertical as it extends downwardly from the frame to the central axle, the strut being cantilevered from the frame.

5. A cycling vehicle as claimed in claim 4 in which the strut is telescopic in length so as to provide suspension travel.

6. A cycling vehicle as claimed in any preceding claim which includes a main sprocket which is connected by a drive member (such as a chain) to a drive sprocket mounted concentric with the central axle, the drive member having, at a time when it is supplying drive to the drive member, a generally straight drive section, the generally straight drive section in at least on configuration thereof being substantially perpendicular to a line extending between two ends of the strut.

7. A cycling vehicle as claimed in any preceding claim in which the strut is cantilevered from the frame in that it has one end thereof fixed to and immobile relative to the frame.

8. A cycling vehicle as claimed in claim 7 in which the strut is cantilevered from the frame without bracing or structural connections from the frame between its point of attachment at one end thereof to the frame and its other end at the drive wheel axle.

9. A cycling vehicle as claimed in any preceding claim in which the strut extends on one side of the drive wheel only, the drive wheel having no support applied from the other side thereof.

10. A cycling vehicle as claimed in any preceding claim in which the drive wheel is rotatable relative to the frame only about the drive axle.

11. A cycling vehicle as claimed in any preceding claim in which the drive wheel is a rear wheel.

12. A cycling vehicle as claimed in any preceding claim which is a bicycle.

13. A cycling vehicle as claimed in any preceding claim in which a second wheel thereof (such as a front wheel) is supported on a single side thereof only, this support being provided by a strut extending from the frame to a central axle of the second wheel.

14. A cycling vehicle as claimed in claim 13 in which the struts of the drive wheel and the second wheel are substantially identical to one another.

15. A cycling vehicle as claimed in any preceding claim in which a gear control is located passing along the axle of the drive wheel from one side to another side of the drive wheel.

16. A cycling vehicle having a frame and a seat member on which a rider may rest the rider's body during cycling, the frame having an extension portion thereof which is substantially a rearward extension of the seat member in at least one position of the seat member thereby enabling sliding movement of the rider's body between the seat member and the extension portion.

17. A cycling vehicle as claimed in claim 16 in which the seat member is adjustable by an adjustment assembly thereof so as to be locatable in more than one position.

18. A cycling vehicle as claimed in any preceding claim in which the frame is a unitary composite structure, such as a carbon fibre composite structure.

19. A cycling vehicle as claimed in any preceding claim which includes foot pedals for a rider to pedal the vehicle along.

20. A cycling vehicle as claimed in claim 19 which includes an auxiliary motor.

21. A cycling vehicle as claimed in claim 20 in which a regenerative braking generator is provided for charging a power source for the motor.

22. A handle and braking assembly for a cycling vehicle, the handle being a generally cylindrical member which is arranged to be grippable and mounted on a steering handlebar arrangement, the handle being rotatable about a longitudinal axis thereof for operating a braking assembly portion of the assembly.

23. A handle and braking assembly as claimed in claim 22 in which the braking assembly portion includes a hydraulic operation device.
